(19) United States
(12) Patent Application Publication
(10) Pub. No.: US 2026/0062596 A1
(43) Pub. Date: Mar. 5, 2026

(54) SILANE-TERMINATED POLYMERS

(71) Applicant: MERZ + Benteli AG, Niederwangen (CH)

(72) Inventors: Stefan HUBER, Langenthal (CH); Thomas ZUBER, Rubigen (CH); Claude LERF, Meyriez (CH); Fritz BURKHARDT, Oberburg (CH)

(73) Assignee: MERZ + Benteli AG, Niederwangen (CH)

(21) Appl. No.: 18/997,711

(22) PCT Filed: Jul. 19, 2023
(86) PCT No.: PCT/EP2023/070075

§ 371 Date: Jan. 22, 2025

(30) Foreign Application Priority Data
Jul. 22, 2022 (EP) 22 186 376.4

(51) Int. Cl. C09J 167/02; C08G 63/91; C09J 5/00

(52) U.S. Cl. CPC C09J 167/02; C08G 63/916; C09J 5/00; C09J 2400/306; C09J 2467/00

(57) ABSTRACT

A composition useful as a wood joint material includes at least 20 wt. % of a silane-terminated polymer, the polymer backbone of which is selected from a polycarbonate, a polyester, a copolymer containing a polyester and/or a polycarbonate, and a polymer containing at least one ester group and/or carbonate group. This polymer backbone contains a plurality of diol monomer, at least 60% of which have the formula HO—Z—OH, where Z is a saturated or unsaturated hydrocarbon chain optionally containing one or more heteroatoms selected from oxygen, sulphur and a tertiary nitrogen, wherein Z includes at least one side chain and/or at least one cyclic ring system and/or at least one double bond, and the composition is free from hardening catalysts or residues thereof selected from base catalysts having a pKa value greater than 15, and from by-products formed when a leaving group is split off during silane termination of the polymer.

The present invention relates to the use of a composition containing silane-terminated polymers.

The silane-terminated polymers are prepared by known methods. A known process comprises, for example, the reaction of polyols, in particular hydroxyl-terminated polyethers, polyurethanes or polyesters, and also of hydroxyl-functional polyacrylates, with (isocyanatoalkyl)alkoxysilanes.

Another method envisages a reaction of the aforementioned polyols with di- or polyisocyanates, using the latter in excess, so that isocyanate-functional polymers are produced in this first reaction step and are then reacted in a second reaction step with alkoxysilanes having an alkyl-bonded isocyanate-reactive group.

The joining of wood, especially of teak joins, places particular demands on the sealant used. Climate- or moisture-related expansion of the teakwood has to be compensated for by the elastic joining compound without cracking or detachment from the wood. Moreover, the sealant is expected to show no wear problems, in addition to rapid curing and good mechanical properties. For this purpose, because of intense insolation, good UV stability and compatibility with oily wood such as teak must also be assured.

WO2006044970 discloses a composition containing an acid component and an amine component. The resulting polyamides are used for joining of teakwood.

EP1657155 discloses a method of caulking a ship's deck.

EP2157109A1 discloses a sealant using a polyurethane-polysiloxane prepolymer produced from at least bifunctional polyols with addition of 1% to 90% by weight of a bifunctional carbinol- or aminoalkyl-terminated polydialkyl-, polydiaryl- or polyalkylarylsiloxane and at least bifunctional aliphatic isocyanate.

WO2015155355 discloses the use of an adhesive for filling of wood joins, where the wood is a natural or synthetic wood.

It has been found in practice that silane-terminated polymers based on polyethers have inadequate UV stability. Although silane-terminated polymers based on polyester and/or polycarbonate have high UV stability, they frequently have relatively low storage stability.

US 2022/220245 discloses a composition comprising a silane-terminated polymer as surface seal or join material. However, the composition disclosed has reduced storage stability.

WO2020094685 discloses a composition comprising a silane-terminated polymer as surface seal or join material.

Isocyanate-free production has been found to be disadvantageous in the case of applications that are subjected to high temperatures since the reaction forms by-products such as phenols that cannot be removed from the end product. This problem has both environmental effects, since such substances can be exuded and get into the environment, and adverse consequences for the quality of the end product, since they lead to yellowing.

It was therefore an object of the present invention to provide a composition containing silane-terminated polymers which have improved storage stability and improved weathering stability and in particular UV stability, and which do not contain any by-products of environmental concern.

The object is achieved by the composition of the invention. Further preferred embodiments are the subject matter of the dependent claims.

It has been found that the composition of the invention containing at least 20% by weight of a silane-terminated polymer of the formula (I) or (II), where the percentages by weight are based on the total content of silane-terminated polymers, and the composition contains a curing catalyst and is free of curing catalysts or residues thereof selected from the group of base catalysts having a pKa of greater than 15, preferably greater than 12, is of excellent suitability as wood joining material since it has both good storage stability and high weathering stability and in particular UV stability. The composition of the invention can reliably prevent damage to the wood as a result of weathering effects, which increases the lifetime thereof. Moreover, maintenance expenditure can be significantly reduced since the wood has to be treated less often. The combination of the branched diol monomer units and the choice of curing catalyst significantly extend storage stability. Moreover, the polymers of the invention are free of by-products that can form via elimination of a leaving group in the case of silane termination of the polymer.

The join may be of any thickness. The composition of the invention can be used for all surface characteristics, i.e. in the case of smooth, structured or rough surfaces.

At least 60 mol % of the diol monomer units, present in the polymer backbone A, of the silane-terminated polymer of the general formula I or II

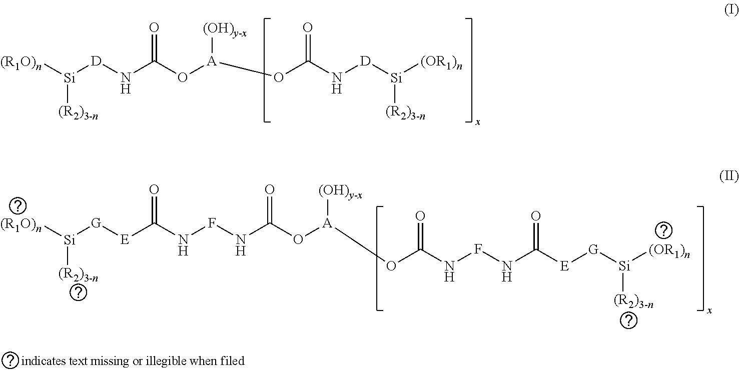

do not have a linear saturated alkylene group, but rather have at least one side chain, one ring system or one double bond. This steric change surprisingly leads to a significantly better storage stability of the composition.

By virtue of the preparation of the inventive silane-terminated polymer of the general formula (I) or (II) and subsequent curing of the formulation with a primary, secondary or oligomeric aminoalkoxysilane, it is possible to avoid unwanted by-products that can form in an isocyanate-free preparation of the silane-terminated polymer. Specifically at high temperatures, such compounds can be exuded, which is environmentally disadvantageous and also adversely affects the quality of the wood joins. The avoidance of these by-products makes it possible to obtain long-lived, in particular visually appealing wood joins, which is important especially in the case of window frames, window shutters, wood facades, terraces, balcony coatings and garden furniture. In the compounds of general formulae I and II
D is a linear or branched hydrocarbon group which has 1 to 20 hydrocarbon atoms and may optionally be interrupted by heteroatoms selected from the group consisting of oxygen, nitrogen and sulfur,
A is a polymer backbone selected from the group consisting of a polycarbonate, a polyester, a copolymer containing a polyester and/or a polycarbonate and a polymer containing at least one ester group and/or carbonate group, and where this polymer backbone A contains multiple diol monomer units,
R₁, R₂, R₁′ and R₂′ are each independently a linear, branched or cyclic hydrocarbon radical which has 1 to 10 carbon atoms and may optionally comprise one or more heteroatoms selected from the group consisting of oxygen, sulfur and nitrogen,
n is the natural number 1, 2 or 3,
x and y are natural numbers from 1 to 10,
G is a linear or branched hydrocarbon group which has 1 to 20 hydrocarbon atoms and may optionally be interrupted by heteroatoms selected from the group consisting of oxygen, nitrogen and sulfur,
F is a linear, branched or cyclic organic radical which does not contain any isocyanate-reactive groups,
E is a functional group selected from the group consisting of NH, NR₄ and S, and
R₄ is a linear, branched or cyclic hydrocarbon radical which has 1 to 10 carbon atoms and may optionally comprise one or more heteroatoms selected from the group consisting of oxygen, sulfur and nitrogen.

In the present invention, a urethane catalyst is a catalyst that catalyzes the reaction of the hydroxy-terminated polymer backbone with an isocyanatosilane or a polyfunctional isocyanate.

A curing catalyst means a catalyst that catalyzes the reaction of the compound of the general formula I or II to form the cured surface seal or the cured join material.

The expression “silane termination” means the reaction step in which the terminal silane group is joined to a silane-terminated polymer. The leaving group formed in the detachment in the silane termination of the polymer is a group of atoms having high electron density that can be readily eliminated in the silane termination. Examples of such leaving groups are aromatic phenols.

At least 60 mol % of the diol monomer units present in the polymer backbone A are a diol of the general formula III

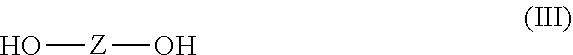

where
Z is a saturated or unsaturated hydrocarbon chain that may optionally contain one or more heteroatoms selected from the group consisting of oxygen, sulfur and a tertiary nitrogen, characterized in that Z has
(a) at least one side chain and/or
(b) at least one cyclic ring system and/or
(c) at least one double bond.

The composition of the invention contains a curing catalyst. However, the choice of curing catalyst is crucial to the storage stability of the formulation of the invention. It is free of curing catalysts selected from the group of base catalysts having a pKa of greater than 15, preferably greater than 12. It has been found that base catalysts that are typically used for the curing of polymers adversely affect storage stability since they can lead to splitting of the polyesters or of the polycarbonates. For example, the commonly used cyclic amidine DBU, which has a pKa of 24.3 in MeCN, leads to a significant reduction in storage stability.

By contrast, curing catalysts having a pKa of less than 15, preferably less than 12, have no adverse effect on storage stability.

Preferably, the curing catalyst contains an aminoalkoxysilane or consists of an aminoalkoxysilane or a mixture of aminoalkoxysilanes, since these are also incorporated by reaction into the polymer network and hence cannot be washed out at a later stage. These additionally also act as an adhesion promoter. The term “aminoalkoxysilanes” especially means primary, secondary or oligomeric aminoalkoxysilanes. A primary aminoalkoxysilane means a compound in which a primary amine is bonded via a linker to the alkoxysilane group, whereas, in the case of a secondary aminoalkoxysilane, a secondary amine group is bonded via a linker to the alkoxysilane group. Examples of secondary aminoalkoxysilanes are N-butyl-3-aminopropyltrimethoxysilane and N-methyl-3-aminopropyltrimethoxysilane. It is likewise possible for primary and secondary amino groups to be bonded to the alkoxysilane group by a linker, for example N-(2-aminoethyl)-3-aminopropyltrimethoxysilane. An oligomeric aminoalkoxysilane is a chemical compound consisting of a chain or group of mutually bonded aminoalkoxysilane molecules. One example of an oligomeric aminoalkoxysilane is, for example, oligomeric diamino-functional Dynasylan 1146 from Evonik or the 3-aminopropyltriethoxysilane dimer (DAPTES dimer). This consists of two molecules of the 3-aminopropyltriethoxysilane monomer.

Preferred curing catalysts are selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane and 7-amino-4-oxaheptyldimethoxymethylsilane, N-(2-aminoethyl)-3-aminopropyltrimethoxysilanes, N-(2-aminoethyl)-3-aminopropylmethyldimethoxysilane, N-(2-aminoethyl)-3-aminopropyltriethoxysilane, 3-[2-(2-aminoethylamino)ethylamino]propyltrimethoxysilane, 3-[2-(2-aminoethylamino)ethylamino]propyltriethoxysilane, 3-[2-(2-aminoethylamino)ethylamino]propylmethyldimethoxysilane, [3-(1-piperazinyl)propyl]triethoxysilane, [3-(1-piperazinyl)propyl]trimethoxysilane, [3-(1-piperazinyl)propyl]methyldimethoxysilane, N-(n-butyl)-3-aminopropyltrimethoxysilane, N-(n-butyl)-3-aminopropylmethyldimethoxysilane, N-(n-butyl)-3-aminopropyltriethoxysilane, N-ethylaminoisobutyltrimethoxysilane, N-ethylaminoisobutylmethyldimethoxysilane, N-cyclohexyl-3-aminopropyltriethoxysilane, N-cyclohexyl-3-aminopropyltrimethoxysilane, N-cyclohexylaminomethyltriethoxysilane, N-cyclohexylaminomethyltrimethoxysilane, N-cyclohexylaminomethyldimethoxymethylsilane, bis(trimethoxysilylpropyl)amine, and oligomeric diamino-functional Dynasylan 1146 from Evonik.

The curing catalyst present in the composition is preferably also free of any metal catalyst and residues thereof, since these too can have an unfavorable effect on storage stability. Examples of such metal catalysts are organotin compounds such as dibutyltin dilaurates, zinc(II) carboxylates, chromium(IV) carboxylates, bismuth(III) carboxylates and potassium(I) carboxylates.

As mentioned, the polymer backbone A is selected from the group consisting of polyesters, polycarbonates and copolymers comprising a polyester and/or a polycarbonate. The expression “copolymers comprising a polyester and/or a polycarbonate” is understood to mean polymers composed of two or more monomer units. In addition to alternating copolymers and graft copolymers, the term also includes, in particular, block polymers which consist of longer sequences or blocks of each monomer and can be linked to one another via linker compounds. Preferred combinations of blocks are
polyesters and polycarbonates
various polyesters
polyesters and polyethers, and
polycarbonates and polyethers.

The expression “copolymer comprising a polyester and/or a polycarbonate” means a copolymer comprising at least one block composed of a polyester and/or a polycarbonate and containing further blocks. In such a copolymer, the polyester content or the polycarbonate content is at least 10% by weight, preferably at least 25% by weight and most preferably at least 50% by weight.

Preferred linker compounds form urethane, ester, urea and amide bonds in the linking, more preferably urethane bonds.

The polymer backbone A contains one or more ester and/or carbonate groups. They preferably contain more than 2, more preferably more than 10 ester and/or carbonate groups. Within the present invention, the definition of the polymer backbone A also includes polymers extended with a linker compound, such as polymers terminally extended with a diol, polymers that have been dimerized or oligomerized by means of a diisocyanate or dicarbonyl dichloride, and copolymers which have been copolymerized using diisocyanates or dicarbonyl dichlorides. Such polymers may have 1, 2 or preferably 3 and more ester and/or carbonate groups within the polymer backbone.

Z is a saturated or unsaturated hydrocarbon chain that may optionally contain one or more heteroatoms selected from the group consisting of oxygen, sulfur and a tertiary nitrogen, wherein Z has
(a) at least one side chain and/or
(b) at least one cyclic ring system and/or
(c) at least one double bond.

The term “side chain” in the present invention means a branch in the saturated or unsaturated hydrocarbon chain. In a preferred embodiment, this is an electron-donating group.

Suitable examples of side chains are a C₁-C₁₀ alkyl, a C₁-C₁₀ alkenyl, preferably with a terminal double bond, a C₁ to C₁₀ alkoxy, a C₁ to C₅ tertiary alkylamino group, an acrylate or a methacrylate. Alkenyl groups having a terminal double bond, acrylates and methacrylates have the advantage that the silane-terminated polymers prepared therefrom can be further crosslinked by radiation.

In one embodiment, Z is an alkylene group having one or more side chains. In the context of the present invention, the term “alkylene group” represents a divalent hydrocarbon radical preferably having 3 to 20 carbon atoms. This has at least one side chain. The side chain may, for example, be a C₁-C₁₀ alkyl, a C₁-C₁₀ alkenyl, a C₁ to C₁₀ alkoxy, a C₁ to C₅ tertiary alkylamino group, an acrylate or a methacrylate. Alkenyl groups having a terminal double bond, acrylates and methacrylates have the advantage that such silane-terminated polymers can be further crosslinked by free-radical means by radiation and heat.

In one embodiment, Z is an alkenylene group that may have one or more side chains. In the context of the present invention, the term “alkenylene group” represents a divalent hydrocarbon radical having at least one double bond and preferably having 3 to 20 carbon atoms. Examples of the optional side chains are, for example, a C₁-C₁₀ alkyl, a C₁-C₁₀ alkenyl, a C₁ to C₁₀ alkoxy, a C₁ to C₅ tertiary alkylamino group, an acrylate or a methacrylate.

In one embodiment, Z is a hydrocarbon chain containing at least one cyclic ring system. In the context of the present invention, the term “cycloalkylene group” represents a divalent, saturated or partially unsaturated, monocyclic, bicyclic or polycyclic ring structure that may be unsubstituted or substituted. The cyclic ring structure may be bonded to the OH groups of the diol of the formula III either directly or via an alkylene group.

Z may be a saturated or unsaturated hydrocarbon chain containing one or more heteroatoms selected from the group consisting of oxygen (i.e. forming an ether), sulfur (i.e. forming a thioether or a thioester) and a tertiary nitrogen (i.e. forming a tertiary amine), which have one or more side chains that may, for example, be a C₁-C₁₀ alkyl, a C₁-C₁₀ alkenyl, a C₁ to C₁₀ alkoxy, a C₁ to C₅ tertiary alkylamino group, an acrylate or a methacrylate.

The composition of the invention is preferably free of phthalates. The composition of the invention is compatible with a wide variety of plasticizers, which makes it possible to dispense with phthalates that are harmful to health.

Preferred non-reactive plasticizers are, for example, phenyl alkanesulfonates such as Mesamoll from Lanxess, cyclohexanoate plasticizers such as Elatur DINCD from Evonik, diisononyl 1,2-cyclohexanedicarboxylates such as Hexamoll DINCH from BASF, and diesters of dicarboxylic acids such as dioctyl sebacate, dioctyl adipate or dioctyl azelate.

Depending on the substrate to be sealed, it is also possible to add reactive plasticizers, for example various linear or branched alkylsilanes (for example N-octyltrimethoxysilane, N-octyldimethoxymethylsilane), monofunctionally silane-terminated polyether polyols (commercially available, for example, as Geniosil XM20, Geniosil XM25, SAT 145, Silquest A-1230 Silane) or likewise alternative monofunctional polymer chains to the composition of the invention.

The composition of the invention contains at least 20% by weight of a silane-terminated polymer of the formula (I) or (II), where the percentages by weight are based on the total content of silane-terminated polymers. The further silane-terminated polymers present in the composition may, for example, be silane-terminated polymers having a polymer backbone based on a polyether, polyacrylate or polyurethane.

In one embodiment, the composition of the invention contains at least 25% by weight, preferably 50% by weight, more preferably 75% by weight, of the silane-terminated polymer of the formula (I) or (II), where the percentages by weight are based on the total content of silane-terminated polymers. The higher the proportion of silane-terminated polymers of the formula (I) or (II), the greater the improvement in weathering resistance.

Possible embodiments are, for example, mixtures of silane-terminated polymers of the formula (I) and/or (II) with
dimethoxy(methyl)silylmethyl carbamate-terminated polyethers, for example Geniosil STP-E10 or STP-E30 from Wacker;
trimethoxysilylpropyl carbamate-terminated polyethers, for example Geniosil STP-E15 or STP-E35 from Wacker, Desmoseal S XP 2636, S XP 2749 from Covestro, Polymer NPT 20S from NPT, SPUR+ 1015 and SPUR+ 1050 from Momentive, Polymer ST 61, Polymer ST 61LV, Polymer ST 80, Polymer ST 81 from Evonik, Risun 15000T, Risun 30000T from Risun;
dimethoxymethylsilane-terminated polyether polymers, for example Polymer S203H, S303H, SAX220, SAX260, SAX350, SAX 400 from Kaneka;
trimethoxysilane-terminated polyether polymers, for example SAX510, SAX520, SAX530, SAX580, SAX 590 from Kaneka;
acryloyl-modified dimethoxymethylsilane-terminated polyether polymers, for example MAX602, MAX 923, MAX951 from Kaneka
acryloyl-modified trimethoxysilane-terminated polyether polymers, for example MA490 from Kaneka
dimethoxysilane-terminated polyacrylates, for example XMAP SA100S, SA110S, SA120S, SA310S, SA420S from Kaneka;
trimethoxysilane-terminated polyurethanes, for example Desmoseal S XP 2458 or S XP 2821 from Covestro.

More preferably, the composition of the invention contains at least 20% by weight of a silane-terminated polymer of the formula (I) or (II), where the percentages by weight are based on the total content of silane-terminated polymers and a further silane-terminated polymer selected from the group consisting of dimethoxy(methyl)silylmethyl carbamate-terminated polyethers and trimethoxysilylpropyl carbamate-terminated polyethers and mixtures thereof is present.

In a preferred embodiment of the present invention, the silane-terminated polymers of the general formula I or II are linear polymers, i.e. x and y are 1. Alternatively, the silane-terminated polymers of the general formula I or II may also be branched polymers. In order to prepare these, a very small portion (about 1 molecule/polymer) of a triol or tricarboxylic acid is used.

In a preferred embodiment of the present invention, Z is a branched alkylene group. This branched alkylene group, i.e. saturated hydrocarbon group, contains at least one side chain. More preferably, the at least one side chain of this alkylene group is selected from the group consisting of methyl, ethyl, propyl, butyl, acrylate and methacrylate, preferably methyl.

In a preferred embodiment, at least 75 mol %, preferably at least 90 mol %, more preferably at least 95 mol % and ideally virtually all diol monomer units contain a diol of the general formula III. The higher the proportion of diols of the general formula III, the better the storage stability of the polymer of the formula I or II in the composition of the invention.

In one embodiment of the present invention, the diol of the formula III is selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 2-ethylhexane-1,3-diol, 1,5-hexadiene-3,4-diol, 7-octene-1,2-diol and (9Z,12Z)-18-[(6Z,9Z)-18-hydroxyoctadeca-6,9-dienoxy]octadeca-9,12-dien-1-ol or a mixture thereof. Polymers of the general formula I or II containing the abovementioned diol of the formula III have particularly good stability. Particularly high stability was achievable with 3-methylpentane-1,5-diol. The preparation of such polymers is known to the person skilled in the art.

In one embodiment of the present invention, A contains a polyester. This can be obtained, for example, by reacting a diol of the general formula III, for example diols selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 2-ethylhexane-1,3-diol, 1,5-hexadiene-3,4-diol, 7-octene-1,2-diol and (9Z,12Z)-18-[(6Z,9Z)-18-hydroxyoctadeca-6,9-dienoxy]octadeca-9,12-dien-1-ol or mixtures thereof with at least one component containing carboxylic groups, selected from aliphatic acids having two carboxyl groups, such as succinic acid, glutaric acid, adipic acid, pimelic acid, suberic acid, azelaic acid, sebacic acid, dodecanedioic acid, brassylic acid and dimer acids, or dialkyl esters of acids having two carboxyl groups, such as dimethyl esters, diethyl esters, dipropyl esters and dibutyl esters or carbonyl chlorides such as acryloyl or methacryloyl chloride; alicyclic dicarboxylic acids such as cyclohexane-1,4-dicarboxylic acid, or dialkyl esters of acids having two carboxyl groups, such as dimethyl esters, diethyl esters, dipropyl esters and dibutyl esters; aromatic acids having two carboxyl groups, such as phthalic acid, isophthalic acid, terephthalic acid and naphthalenedicarboxylic acid, or dialkyl esters of acids having two carboxyl groups, such as dimethyl esters, diethyl esters, dipropyl esters and dibutyl esters and the like, or mixtures thereof. The preparation of such polymers is known to the person skilled in the art.

Of these examples, preference is given to using adipic acid, azelaic acid, sebacic acid, terephthalic acid, isophthalic acid and naphthalenedicarboxylic acid or mixtures thereof.

Also possible is the use of cyclic carboxylic anhydrides such as phthalic anhydride, maleic anhydride, succinic anhydride or with a side chain, for example 3-methylglutaric anhydride, or mixtures thereof. Aliphatic dicarboxylic acids or esters thereof having side chains may also be used, such as 2,4-diethylglutaric acid, 2,4-methylglutaric acid, 3-methylglutaric acid, methylmalonic acid or mixtures thereof. The diols and also the dicarboxylic acids may be petroleum-based or may have been produced from renewable raw materials. However, the expression “polyester” also includes polyesters formed by reaction of diols of the general formula III with caprolactone.

In one embodiment, the polymer backbone A contains a polycarbonate. Polycarbonates may be obtained, for example, by the reaction of diols of the formula III, for example diols selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 1,5-hexadiene-3,4-diol, 2-ethylhexane-1,3-diol, 7-octene-1,2-diol and (9Z,12Z)-18-[(6Z,9Z)-18-hydroxyoctadeca-6,9-dienoxy]octadeca-9,12-dien-1-ol or mixtures of two or more of these with diaryl carbonates, for example dimethyl carbonate, diethyl carbonate, diphenyl carbonate or phosgene. The preparation of such polymers is known to the person skilled in the art.

The isocyanates of the formula (IV) used according to the invention

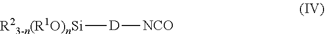

are commercially available products or can be produced by standard methods in silicon chemistry. R₁ and R₂ are each independently a linear, branched or cyclic hydrocarbon radical having 1 to 10 carbon atoms, which may optionally comprise one or more heteroatoms selected from the group consisting of oxygen, sulfur and nitrogen. n may have the value 1, 2 or 3, with the values 2 or 3 being preferred, since the silane-terminated polymers produced therefrom have a particularly balanced reactivity.

Preferably, R¹ and R² are each independently alkyl radicals, such as a methyl radical, ethyl radical, n-propyl radical, isopropyl radical, n-butyl radical, isobutyl radical, tert-butyl radical, n-pentyl radical, isopentyl radical, neopentyl radical, tert-pentyl radical, n-hexyl radical, n-heptyl radical, octyl radicals, n-octyl radical, isooctyl radicals, 2,2,4-trimethylpentyl radical, n-nonyl radical, decyl radicals, n-decyl radical, dodecyl radicals or an n-dodecyl radical. They may, however, also be alkenyl radicals, such as a vinyl radical or an allyl radical; cycloalkyl radicals, such as a cyclopentyl radical, cyclohexyl radical, cycloheptyl radical and methylcyclohexyl radicals; aryl radicals, such as the phenyl radical and the naphthyl radical; alkaryl radicals, such as o-, m-, p-tolyl radicals, xylyl radicals and ethylphenyl radicals; aralkyl radicals, such as the benzyl radical, the α-phenylethyl radical and the β-phenylethyl radical. Examples of substituted radicals R¹ are alkoxyalkyl radicals, such as ethoxyethyl radicals and methoxyethyl radicals.

Preferably, R¹ and R² radicals are each independently a hydrocarbon radical having 1 to 6 carbon atoms, particularly preferably an alkyl radical having 1 to 4 carbon atoms, in particular the methyl radical or ethyl radical.

D is a linear or branched hydrocarbon group having 1 to 20 hydrocarbon atoms, which may optionally be interrupted by heteroatoms selected from the group consisting of oxygen, nitrogen and sulfur. Preferably, D is selected from the group consisting of methylene, ethylene, propylene, butylene, methylene oxide, ethylene oxide and propylene oxide, and particularly preferably from propylene or methylene, since this results in polymers having a particularly balanced reactivity and these are readily commercially available.

Examples of isocyanates of the formula (IV) are isocyanatomethyldimethylmethoxysilane, isocyanatopropyldimethylmethoxysilane, isocyanatomethylmethyldimethoxysilane, isocyanatopropylmethyldimethoxysilane, isocyanatomethyltrimethoxysilane, isocyanatomethyltriethoxysilane, isocyanatopropyltriethoxysilane and isocyanatopropyltrimethoxysilane, preference being given to isocyanatomethylmethyldimethoxysilane, isocyanatopropylmethyldimethoxysilane, isocyanatopropyltrimethoxysilane, isocyanatopropyltriethoxysilane and isocyanatomethyltriethoxysilane.

The process according to the invention for preparing the silane-terminated polymer of the formula (II) is effected by reacting a hydroxy-terminated organic polymer of the formula (III)

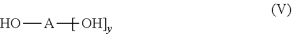

where A represents the above-defined polymer backbone with a polyfunctional isocyanate of the formula (VI)

F—(N═C═O)ₘ

and subsequent reaction with an alkoxysilane of the formula (VII)

R^{2′}₃₋ₙ(R^{1′}O)ₙSi-G-E₁ (VII)

in the presence of a urethane catalyst, where E₁ is a reactive group that reacts with the isocyanate group, selected from the group consisting of NH₂, NHR₃ and SH, and F, m, R₁′, R₂′, n and G have the same definition as above. It has been found that this process leads to much better results compared to isocyanate-free processes since it is possible to avoid elimination products, by-products or degradation products of toxicological concern, which can also adversely affect the quality of the teakwoods.

The reaction with the polyfunctional isocyanate of the formula (VI) is preferably conducted at 60-150° C., more preferably at 60-120° C., and the reaction with the alkoxysilane of the formula (VII) is preferably conducted at 0-100° C., more preferably at 20-60° C.

The hydroxy-terminated organic polymer of the formula (III) preferably has an average molecular weight of 1000-50 000 g/mol, in particular 2000-25 000 g/mol, since the handling of said polymers is optimal, optionally with addition of a plasticizer to improve processibility. In the present document, “molecular weight” means the molar mass (in grams per mole) of a molecule. “Average molecular weight” refers to the number-average molecular weight Mn of a polydisperse mixture of oligomeric or polymeric molecules, which is usually determined by titrating the acid number and OH number. It can alternatively also be determined by analytical methods such as GPC/MALDI. The OH number (hydroxyl number) is a measure of the hydroxyl group content in polymers and is a quantity known to those skilled in the art. The acid number is a measure of the content of acid groups in polymers and is a quantity known to those skilled in the art.

Particularly suitable polyfunctional isocyanates of the formula (VI) are isocyanates having two or more, preferably 2 to 10, isocyanate groups in the molecule. Suitable for this purpose are the known aliphatic, cycloaliphatic, aromatic, oligomeric and polymeric polyfunctional isocyanates which do not contain any isocyanate-reactive groups, i.e. in particular have no free primary and/or secondary amino groups. An example of a representative of the aliphatic polyfunctional isocyanates is hexamethylene diisocyanate (HDI); an example of a representative of the cycloaliphatic polyfunctional isocyanates is 1-isocyanato-3-(isocyanatomethyl)-3,5,5-trimethylcyclohexane.

Representatives of the aromatic polyfunctionalized isocyanates include: 2,4- and 2,6-diisocyanatotoluene and the corresponding technical isomer mixture (TDI); diphenylmethane diisocyanates, such as diphenylmethane 4,4′-diisocyanate, diphenylmethane-2,4′-diisocyanate, diphenylmethane 2,2′-diisocyanate and the corresponding technical isomer mixtures (MDI). In addition, mention should also be made of naphthalene-1,5-diisocyanate (NDI) and 4,4′,4″-triisocyanatotriphenylmethane.

Alkoxysilanes of the formula (VII) are preferably selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane and 7-amino-4-oxaheptyldimethoxymethylsilane, N-(2-aminoethyl)-3-aminopropyltrimethoxysilane, N-(2-aminoethyl)-3-aminopropylmethyldimethoxysilane, N-(2-aminoethyl)-3-aminopropyltriethoxysilane, 3-[2-(2-aminoethylamino)ethylamino]propyltrimethoxysilane, 3-[2-(2-aminoethylamino)ethylamino]propyltriethoxysilane, 3-[2-(2-aminoethylamino)ethylamino]propylmethyldimethoxysilane, [3-(1-piperazinyl)propyl]triethoxysilane, [3-(1-piperazinyl)propyl]trimethoxysilane, [3-(1-piperazinyl)propyl]methyldimethoxysilane, N-(n-butyl)-3-aminopropyltrimethoxysilane, N-(n-butyl)-3-aminopropylmethyldimethoxysilane, N-(n-butyl)-3-aminopropyltriethoxysilane, N-ethylaminoisobutyltrimethoxysilane, N-ethylaminoisobutylmethyldimethoxysilane, N-cyclohexyl-3-aminopropyltriethoxysilane, N-cyclohexyl-3-aminopropyltrimethoxysilane, N-cyclohexylaminomethyltriethoxysilane, N-cyclohexylaminomethyltrimethoxysilane, N-cyclohexylaminomethyldimethoxymethylsilane, bis(trimethoxysilylpropyl)amine, 3-mercaptopropyltrimethoxysilane, 3-mercaptopropyltriethoxysilane and 3-mercaptopropylmethyldimethoxysilane.

The composition of the invention preferably contains at least 0.1% by weight of a UV stabilizer in order to further improve the stability of the composition.

A further embodiment of the present invention relates to a composition of the invention in which, when the diol of the formula III is 3-methylpentane-1,5-diol, the acid unit is not adipic acid.

Particularly good results were obtained with the following silane-terminated polymers selected from the group consisting of

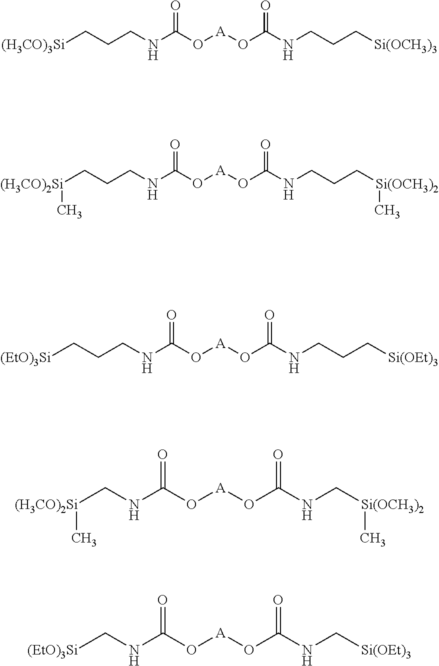

where A contains polyester units formed from monomer units selected from the group consisting of

| | | |
|---|---|---|
| A1 | neopentyl glycol | adipic acid |
| A2 | propane-1,2-diol | adipic acid |
| A3 | cyclohexane-1,4-dimethanol | adipic acid |
| A4 | 3-methylpentane-1,5-diol | adipic acid |
| A5 | 2-methylpentane-2,4-diol | adipic acid |
| A6 | hexane-2,5-diol | adipic acid |
| A7 | 2-butyl-2-ethylpropane-1,3-diol | adipic acid |
| A8 | 2-methylpropane-1,3-diol | adipic acid |
| A9 | 3-ethylpentane-1,5-diol | adipic acid |
| A10 | 2,4-diethylpentane-1,5-diol | adipic acid |
| A11 | 2,2,4-trimethylpentane- | adipic acid |
| | 1,3-diol | |
| A12 | butane-2,3-diol | adipic acid |
| A13 | 2-ethylpentane-1,5-diol | adipic acid |
| A14 | 2,2-dimethylpropane-1,3-diol | adipic acid |
| A15 | 2-ethylhexane-1,3-diol | adipic acid |
| A16 | 1,5-hexadiene-3,4-diol | adipic acid |
| A17 | 7-octene-1,2-diol | adipic acid |
| A18 | (9Z,12Z)-18-[(6Z,9Z)-18- | adipic acid |
| | hydroxyoctadeca-6,9- | |
| | dienoxy]octadeca-9,12- | |
| | dien-1-ol | |
| A19 | neopentyl glycol | azelaic acid |
| A20 | propane-1,2-diol | azelaic acid |
| A21 | cyclohexane-1,4-dimethanol | azelaic acid |
| A22 | 3-methylpentane-1,5-diol | azelaic acid |
| A23 | 2-methylpentane-2,4-diol | azelaic acid |
| A24 | hexane-2,5-diol | azelaic acid |
| A25 | 2-butyl-2-ethylpropane- | azelaic acid |
| | 1,3-diol | |
| A26 | 2-methylpropane-1,3-diol | azelaic acid |
| A27 | 3-ethylpentane-1,5-diol | azelaic acid |
| A28 | 2,4-diethylpentane-1,5- | azelaic acid |
| | diol | |
| A29 | 2,2,4-trimethylpentane- | azelaic acid |
| | 1,3-diol | |
| A30 | butane-2,3-diol | azelaic acid |
| A31 | 2-ethylpentane-1,5-diol | azelaic acid |
| A32 | 2,2-dimethylpropane-1,3- | azelaic acid |
| | diol | |
| A33 | 2-ethylhexane-1,3-diol | azelaic acid |
| A34 | 1,5-hexadiene-3,4-diol | azelaic acid |
| A35 | 7-octene-1,2-diol | azelaic acid |
| A36 | (9Z,12Z)-18-[(6Z,9Z)-18- | azelaic acid |
| | hydroxyoctadeca-6,9- | |
| | dienoxy]octadeca-9,12- | |
| | dien-1-ol | |
| A37 | neopentyl glycol | sebacic acid |
| A38 | propane-1,2-diol | sebacic acid |
| A39 | cyclohexane-1,4- | sebacic acid |
| | dimethanol | |
| A40 | 3-methylpentane-1,5-diol | sebacic acid |
| A41 | 2-methylpentane-2,4-diol | sebacic acid |
| A42 | hexane-2,5-diol | sebacic acid |
| A43 | 2-butyl-2-ethylpropane- | sebacic acid |
| | 1,3-diol | |
| A44 | 2-methylpropane-1,3-diol | sebacic acid |
| A45 | 3-ethylpentane-1,5-diol | sebacic acid |
| A46 | 2,4-diethylpentane-1,5- | sebacic acid |
| | diol | |
| A47 | 2,2,4-trimethylpentane- | sebacic acid |
| | 1,3-diol | |
| A48 | butane-2,3-diol | sebacic acid |
| A49 | 2-ethylpentane-1,5-diol | sebacic acid |
| A50 | 2,2-dimethylpropane-1,3- | sebacic acid |
| | diol | |
| A51 | 2-ethylhexane-1,3-diol | sebacic acid |
| A52 | 1,5-hexadiene-3,4-diol | sebacic acid |
| A53 | 7-octene-1,2-diol | sebacic acid |
| A54 | (9Z,12Z)-18-[(6Z,9Z)-18- | sebacic acid |
| | hydroxyoctadeca-6,9- | |
| | dienoxy]octadeca-9,12- | |
| | dien-1-ol | |
| A55 | neopentyl glycol | terephthalic acid |
| A56 | propane-1,2-diol | terephthalic acid |
| A57 | cyclohexane-1,4-dimethanol | terephthalic acid |
| A58 | 3-methylpentane-1,5-diol | terephthalic acid |
| A59 | 2-methylpentane-2,4-diol | terephthalic acid |
| A60 | hexane-2,5-diol | terephthalic acid |
| A61 | 2-butyl-2-ethylpropane- | terephthalic acid |
| | 1,3-diol | |
| A62 | 2-methylpropane-1,3-diol | terephthalic acid |
| A63 | 3-ethylpentane-1,5-diol | terephthalic acid |
| A64 | 2,4-diethylpentane-1,5- | terephthalic acid |
| | diol | |
| A65 | 2,2,4-trimethylpentane- | terephthalic acid |
| | 1,3-diol | |
| A66 | butane-2,3-diol | terephthalic acid |
| A67 | 2-ethylpentane-1,5-diol | terephthalic acid |
| A68 | 2,2-dimethylpropane-1,3-diol | terephthalic acid |
| A69 | 2-ethylhexane-1,3-diol | terephthalic acid |
| A70 | 1,5-hexadiene-3,4-diol | terephthalic acid |
| A71 | 7-octene-1,2-diol | terephthalic acid |
| A72 | (9Z,12Z)-18-[(6Z,9Z)-18- | terephthalic acid |
| | hydroxyoctadeca-6,9- | |
| | dienoxy]octadeca-9,12- | |
| | dien-1-ol | |
| A73 | neopentyl glycol | isophthalic acid |
| A74 | propane-1,2-diol | isophthalic acid |
| A75 | cyclohexane-1,4-dimethanol | isophthalic acid |
| A76 | 3-methylpentane-1,5-diol | isophthalic acid |
| A77 | 2-methylpentane-2,4-diol | isophthalic acid |
| A78 | hexane-2,5-diol | isophthalic acid |
| A79 | 2-butyl-2-ethylpropane- | isophthalic acid |
| | 1,3-diol | |
| A80 | 2-methylpropane-1,3-diol | isophthalic acid |
| A81 | 3-ethylpentane-1,5-diol | isophthalic acid |
| A82 | 2,4-diethylpentane-1,5-diol | isophthalic acid |
| A83 | 2,2,4-trimethylpentane- | isophthalic acid |
| | 1,3-diol | |
| A84 | butane-2,3-diol | isophthalic acid |
| A85 | 2-ethylpentane-1,5-diol | isophthalic acid |
| A86 | 2,2-dimethylpropane-1,3- | isophthalic acid |
| | diol | |
| A87 | 2-ethylhexane-1,3-diol | isophthalic acid |
| A88 | 1,5-hexadiene-3,4-diol | isophthalic acid |
| A89 | 7-octene-1,2-diol | isophthalic acid |
| A90 | (9Z,12Z)-18-[(6Z,9Z)-18- | isophthalic acid |
| | hydroxyoctadeca-6,9- | |
| | dienoxy]octadeca-9,12- | |
| | dien-1-ol | |
| A91 | neopentyl glycol | naphthalenedicarboxylic |
| | | acid |
| A92 | propane-1,2-diol | naphthalenedicarboxylic |
| | | acid |
| A93 | cyclohexane-1,4-dimethanol | naphthalenedicarboxylic |
| | | acid |
| A94 | 3-methylpentane-1,5-diol | naphthalenedicarboxylic |
| | | acid |
| A95 | 2-methylpentane-2,4-diol | naphthalenedicarboxylic acid |
| A96 | hexane-2,5-diol | naphthalenedicarboxylic acid |
| A97 | 2-butyl-2-ethylpropane-1,3-diol | naphthalenedicarboxylic acid |
| A98 | 2-methylpropane-1,3-diol | naphthalenedicarboxylic acid |
| A99 | 3-ethylpentane-1,5-diol | naphthalenedicarboxylic acid |
| A100 | 2,4-diethylpentane-1,5-diol | naphthalenedicarboxylic |
| | | acid |
| A101 | 2,2,4-trimethylpentane-1,3-diol | naphthalenedicarboxylic |
| | | acid |
| A102 | butane-2,3-diol | naphthalenedicarboxylic |
| | | acid |
| A103 | 2-ethylpentane-1,5-diol | naphthalenedicarboxylic |
| | | acid |
| A104 | 2,2-dimethylpropane-1,3-diol | naphthalenedicarboxylic |
| | | acid |
| A105 | 2-ethylhexane-1,3-diol | naphthalenedicarboxylic acid |
| A106 | 1,5-hexadiene-3,4-diol | naphthalenedicarboxylic |
| | | acid |
| A107 | 7-octene-1,2-diol | naphthalenedicarboxylic |
| | | acid |
| A108 | (9Z,12Z)-18-[(6Z,9Z)-18- | naphthalenedicarboxylic |
| | hydroxyoctadeca-6,9- | acid |
| | dienoxy]octadeca-9,12-dien-1-ol | naphthalenedicarboxylic |
| | | acid |

The polyesters thus formed preferably have a molecular weight of 1000 g/mol to 20 000 g/mol.

The composition of the invention is more preferably used joining of hardwood selected from the group consisting of tropical and subtropical woods, maple, apple, birch, pear, beech, yew, oak, ash, cherry and walnut. Particularly preferred tropical and subtropical woods are selected from the group consisting of acacia, bangkirai, balau, bongossi, doussie, iroko, ipé, mahogany, meranti, palisander, sapelli mahogany, sipo mahogany, teak and wenge. The composition of the invention has exceptionally good adhesion to these woods and protects these reliably from ingress of moisture. By virtue of the excellent UV stability, it can also be used in places exposed to the sun.

The composition of the invention is alternatively suitable for joining softer woods, especially woods selected from the group consisting of alder, spruce, pine, larch, Douglas fir, lime, pitch pine and fir.

The composition of the invention is also suitable in particular for joining of significantly oily and/or resinous woods. These are particularly demanding in terms of joining since good adhesion can be developed only with difficulty, and the constituents of the wood can greatly reduce the weathering stability of the joining compound. Examples of oily and/or resinous woods are teak, pitch pine, larch, spruce and iroko.

The composition of the invention is especially suitable for joining of woods and planks that are subject to significant weathering conditions, such as window frames, window shutters, wood facades, terraces, balcony coatings, garden furniture, doors and surfaces in shipbuilding, especially for joining of ship's planks.

The composition of the invention in particular also shows good weathering stability and adhesion under the influence of seawater or saltwater.

The composition of the invention shows thixotropic characteristics and can be applied both to horizontal and vertical wood surfaces. It is thus especially suitable as a joining means for vertical join seals and horizontal join seals.

The composition of the invention, after application and curing, may be sanded, for example, with an eccentric sander or a belt sander.

The composition of the invention is especially suitable for joining of teak planks. The construction of a teak deck first requires the joining of teak boards to the underdeck of the ship, which may have been manufactured from a metal (for example aluminum), a metal alloy (for example steel or painted steel) or a material comprising polyester (for example reinforced polyester), or from wood (for example plywood). These teak planks may have, for example, a cuboidal form with a length between 10 cm and 5 meters, a width between 3 and 20 cm, and a thickness between 4 mm and 4 cm. Teak planks, depending on the respective geometry of the part of the ship's deck, may also be available in various other forms. They are generally supplied with different cross-sectional types, for example a rectangular cross section, or with a T profile or an L profile. After the teak planks have been bonded to the underdeck of the ship, a clear interspace (also referred to as a seam) remains between adjacent planks, which essentially has the form of a strip having a width between 3 and 20 mm (preferably between 5 and 10 mm) and a depth between 6 and 10 mm. The seam is usually a straight strip which is parallel to each side of the rectangular teak planks. In the case of teak planks having a form other than a cuboidal form, the seam follows the circumference of such planks and is not necessarily a straight strip. The joining of these seams with the composition of the invention prevents dust, soil, moisture, chemicals or seawater from penetrating into the seam. This can prevent damage or corrosion to the ship's deck or underdeck.

The composition of the invention especially has good stability to the acidic, neutral or basic treatment, cleaning and bleaching products that are used on wood, such as oxalic acid solutions and sodium hydroxide solutions.

The composition of the invention is especially also suitable for joining of wood-plastic composites (WPCs). These materials may consist of 50% or more wood constituents.

The silane-terminated polymers of the invention may also be formulated as a 2-component system. In addition to auxiliaries, the second component also comprises water, which greatly accelerates deep through-curing after mixing with the first component. Corresponding 2-component systems are known to those skilled in the art and are described, for example, in EP2009063 or EP2535376, the content of which is incorporated by reference.

The compositions of the invention may contain further auxiliaries and additives. These auxiliaries and additives include, for example, further silane-terminated polymers, plasticizers, stabilizers, antioxidants, fillers, reactive diluents, desiccants, adhesion promoters and UV stabilizers, rheological aids, color pigments or color pastes, and/or possibly also solvents to a small extent. Such auxiliaries and additives are known to those skilled in the art.

The formulation of the present invention may be black, white, colored or transparent, meaning that the color can be matched to individual customer wishes. In order to obtain the desired color, it may additionally contain one or more color pigments.

Because of the high weathering stability, no loss of color of the joins or cracking at the join surface is observed even after prolonged weathering time.

### EXAMPLES

### Example 1

A silane-terminated Dynacoll 7250 (not in accordance with the invention, polyester based on linear ethane-1,2-diol, linear hexane-1,6-diol and small amounts of 2,2-dimethylpropane-1,3-diol and adipic acid) is compared with an inventive silane-terminated Kuraray P-6010 (3-methylpentane-1,5-diol as diol component, in accordance with the invention, and adipic acid as acid component):

| | Noninventive | Inventive |
|---|---|---|
| trimethoxypropylsilane- | 35 | |
| terminated Dynacoll 7250 | | |
| trimethoxypropylsilane- | | 35 |
| terminated Kuraray P-6010 | | |
| Plasticizer | 9 | 9 |
| Vinyltrimethoxysilane | 1 | 1 |
| Omyalite 95T | 50 | 50 |
| Titanium dioxide | 2 | 2 |
| Sterically hindered amine as | 0.1 | 0.1 |
| light stabilizer | | |
| Antioxidant | 0.4 | 0.4 |
| Polyamide wax | 2 | 2 |
| 3-Aminopropyltrimethoxysilane | 0.5 | 0.5 |
| Total | 100 | 100 |

| | | | | 4 |
|---|---|---|---|---|
| Storage in cartridge at 50° C. | Start | 4 weeks | Start | weeks |
| Shore A (4 weeks n.c.) | 62 | 15 | 69 | 64 |
| Tensile strength (1 week n.c. + | 2.73 | 0.59 | 3.61 | 3.58 |
| 1 week 50° C.) [MPa] | | | | |
| Elongation at b break (1 week | 108 | 81 | 115 | 114 |
| n.c. + 1 week 50° C.) [%] | | | | |

n.c. = standard conditions, 23° C./50% r.h.

### Example 2

The inventive composition according to example 1 was compared with a composition consisting of silane-terminated polyether polymers, and was applied as a join between two teak planks, sanded with an eccentric sander and stored in a xenon weathering device. While the join based on silane-terminated polyethers showed the first cracks after only 2000 h of artificial weathering, the composition based on silane-terminated polyesters is still undamaged even after 8000 h.

Blends of the composition of the invention with a proportion of silane-terminated polyether polymers also show much better weathering stability than compositions based on pure silane-terminated polyether polymers or pure silane-terminated polyurethane polymers.

### Example 3

The stability of the polymers of the invention was compared with those having a higher polyether content:

| | P9 | P10 |
|---|---|---|
| Polyester (MPeD/AA) according to example 1 | 31.8 | 25.4 |
| Polyether (STP E-35, Wacker) | | 6.4 |
| water scavenger (TMS-silane) | 1.7 | 1.7 |
| GCC (treated calcium carbonates), d50: 2.8 μm | 45.5 | 45.5 |
| Printex G (black carbon) | | |
| Titanium dioxide | 2.1 | 2.1 |
| Addworks 720 (HALS/AO/UVA) | 0.1 | 0.1 |
| Irganox 1135 (HALS) | 0.4 | 0.4 |
| Plasticizer | 16.1 | 16.1 |
| Polyamide wax | 0.5 | 0.5 |
| Oligomeric aminosilane | 0.6 | 0.6 |
| Secondary aminosilane | 1.2 | 1.2 |
| Total [g] | 100 | 100 |

| | Curing before grinding time | | | | | | | |
|---|---|---|---|---|---|---|---|---|
| | 24 h | 24 h | 48 h | 48 h | 24 h | 24 h | 48 h | 48 h |
| Aftertreatment | none | teak | none | teak | none | teak | none | teak |
| | | oil | | oil | | oil | | oil |
| Initial loss | none | none | none | none | none | none | none | none |
| of color | | | | | | | | |
| Loss of | none | none | none | none | none | none | none | none |
| color after | | | | | | | | |
| weathering | | | | | | | | |
| for 72 h | | | | | | | | |
| Loss of | none | none | none | none | none | none | none | none |
| color after | | | | | | | | |
| weathering | | | | | | | | |
| for 240 h | | | | | | | | |
| Loss of | none | none | none | none | none | none | none | none |
| color after | | | | | | | | |
| weathering | | | | | | | | |
| for 384 h | | | | | | | | |
| Loss of | none | none | none | none | none | none | none | none |
| color after | | | | | | | | |
| weathering | | | | | | | | |
| for 576 h | | | | | | | | |
| Loss of | none | none | none | none | none | none | none | none |
| color after | | | | | | | | |
| weathering | | | | | | | | |
| for 1080 h | | | | | | | | |
| Loss of | none | none | none | none | none | none | none | none |
| color after | | | | | | | | |
| weathering | | | | | | | | |
| for 1512 h | | | | | | | | |
| Loss of | none | none | none | none | none | none | none | none |
| color after | | | | | | | | |
| weathering | | | | | | | | |
| for 1896 h | | | | | | | | |

| | P11 | P12 |
|---|---|---|
| Polyester (MPeD/AA) according to example 1 | 19.1 | 15.9 |
| Polyether (STP E-35, Wacker) | 12.7 | 15.9 |
| water scavenger (TMS-silane) | 1.7 | 1.7 |
| GCC (treated calcium carbonates), d50: 2.8 μm | 45.5 | 45.5 |
| Printex G (black carbon) | | |
| Titanium dioxide | 2.1 | 2.1 |
| Addworks 720 (HALS/AO/UVA) | 0.1 | 0.1 |
| Irganox 1135 (HALS) | 0.4 | 0.4 |
| Plasticizer | 16.1 | 16.1 |
| Polyamide wax | 0.5 | 0.5 |
| Oligomeric aminosilane | 0.6 | 0.6 |
| Secondary aminosilane | 1.2 | 1.2 |
| Total [g] | 100 | 100 |

| | Curing before grinding time | | | | | | | |
|---|---|---|---|---|---|---|---|---|
| | 24 h | 24 h | 48 h | 48 h | 24 h | 24 h | 48 h | 48 h |
| Aftertreatment | none | teak | none | teak | none | teak | none | teak |
| | | oil | | oil | | oil | | oil |
| Initial loss | none | none | none | none | none | none | none | none |
| of color | | | | | | | | |
| Loss of | none | none | none | none | none | none | none | none |
| color after | | | | | | | | |
| weathering | | | | | | | | |
| for 72 h | | | | | | | | |
| Loss of | none | none | none | none | none | none | none | none |
| color after | | | | | | | | |
| weathering | | | | | | | | |
| for 240 h | | | | | | | | |
| Loss of | none | none | none | none | none | none | none | none |
| color after | | | | | | | | |
| weathering | | | | | | | | |
| for 384 h | | | | | | | | |
| Loss of | slight | slight | slight | slight | slight | slight | slight | slight |
| color after | | | | | | | | |
| weathering | | | | | | | | |
| for 576 h | | | | | | | | |
| Loss of | slight | slight | slight | slight | slight | slight | slight | slight |
| color after | | | | | | | | |
| weathering | | | | | | | | |
| for 1080 h | | | | | | | | |
| Loss of | slight | slight | slight | slight | slight | slight | slight | slight |
| color after | | | | | | | | |
| weathering | | | | | | | | |
| for 1512 h | | | | | | | | |
| Loss of | slight | slight | slight | slight | slight | slight | slight | slight |
| color after | | | | | | | | |
| weathering | | | | | | | | |
| for 1896 h | | | | | | | | |

| | P13 | P14 |
|---|---|---|
| Polyester (MPeD/AA) according to example 1 | 9.5 | 6.4 |
| Polyether (STP E-35, Wacker) | 22.3 | 25.4 |
| water scavenger (TMS-silane) | 1.7 | 1.7 |
| GCC (treated calcium carbonates), d50: 2.8 μm | 45.5 | 45.5 |
| Printex G (black carbon) | | |
| Titanium dioxide | 2.1 | 2.1 |
| Addworks 720 (HALS/AO/UVA) | 0.1 | 0.1 |
| Irganox 1135 (HALS) | 0.4 | 0.4 |
| Plasticizer | 16.1 | 16.1 |
| Polyamide wax | 0.5 | 0.5 |
| Oligomeric aminosilane | 0.6 | 0.6 |
| Secondary aminosilane | 1.2 | 1.2 |
| Total [g] | 100 | 100 |

| | Curing before grinding time | | | | | | | |
|---|---|---|---|---|---|---|---|---|
| | 24 h | 24 h | 48 h | 48 h | 24 h | 24 h | 48 h | 48 h |
| Aftertreatment | none | teak oil | none | teak oil | none | teak oil | none | teak oil |
| Initial loss of color | none | none | none | none | none | none | none | none |
| Loss of color after | none | none | none | none | none | none | none | none |
| weathering for 72 h | | | | | | | | |
| Loss of color after | none | none | none | none | none | none | none | slight |
| weathering for 240 h | | | | | | | | |
| Loss of color after | none | none | none | none | slight | slight | slight | slight |
| weathering for 384 h | | | | | | | | |
| Loss of color after | slight | slight | slight | slight | slight | slight | slight | slight |
| weathering for 576 h | | | | | | | | |
| Loss of color after | slight | slight | slight | slight | moderate | moderate | moderate | moderate |
| weathering for 1080 h | | | | | | | | |
| Loss of color after | slight | slight | slight | slight | moderate | moderate | moderate | moderate |
| weathering for 1512 h | | | | | | | | |
| Loss of color after | slight | slight | slight | slight | significant | significant | significant | significant |
| weathering for 1896 h | | | | | | | | |

The following tests were conducted with the inventive composition and the comparative compositions:

Loss of color of the mass (black product/white product) in contact with teak wood, sanding of the mass after curing for 24 h/48 h, treatment with/without teak oil. Weathering in the xenon test instrument.

It was shown that there is a distinct decrease in weathering stability with a higher proportion of polyether polymer (Wacker STP-E35).

### Example 4

The example shows the effect of the catalyst and the effect of the diol monomer units having a side group on storage stability.

### Materials Used:

Dynacoll® 7250 (Evonik): linear polyester polyol prepared from ethane-1,2-diol (unbranched), hexane-1,6-diol (unbranched), 2,2-dimethylpropane-1,3-diol (branched) with adipic acid, where the polyol has an average molar mass of 5,500 g/mol. According to NMR analyses, Dynacoll 7250, based on the diol components, contains about 17 mol % of branched diol (2,2-dimethylpropane-1,3-diol).

Dynacoll® 7231 (sold at Evonik): linear polyester polyol prepared from ethane-1,2-diol (unbranched), hexane-1,6-diol (unbranched), 2,2-dimethylpropane-1,3-diol (branched) with adipic acid, terephthalic acid and isophthalic acid, where the polyol has an average molar mass of 3,500 g/mol.

Dynacoll® 7230 (sold at Evonik) linear polyester polyol prepared from ethane-1,2-diol (unbranched), hexane-1,6-diol (unbranched), 2,2-dimethylpropane-1,3-diol (branched) with adipic acid, terephthalic acid and isophthalic acid, where the polyol has an average molar mass of 3,500 g/mol.

The hydroxy-terminated polyols were modified to give silane-terminated polymers, after prior drying at 100° C. under reduced pressure, as follows: breaking of the vacuum with nitrogen. cooling under N2 to 80° C. Addition of urethane catalyst in the form of a mixture of cobalt(II) neodecanoate in white spirit, where the content of cobalt(II) ions was chosen according to the reactivity of the prepolymers and was between 4-10 ppm. Homogenization was followed by the addition of an equimolar amount of 3-(trimethoxysilyl)propyl isocyanates. The reaction was left to run at 80° C. until the isocyanate band, which is detectable at around 2270 cm⁻¹ in the FTIR analysis, has been fully depleted. Subsequently, the products were discharged into a sealed reservoir vessel and stored under nitrogen until further processing according to the examples.

| | According to | Not according to |
|---|---|---|
| | the invention | the invention |
| Polymer (MPeD/AA) from example 1 | 32.2 | 32.2 |
| Polymer (7250) example 2 | | |
| Polymer (7230) example 3 | | |
| Polymer (7231) example 4 | | |
| Polymer (EPG/EPeD/SA) example 5 | | |
| Polymer (MPeD/SA) example 6 | | |
| Water absorber (TMS-silane) | 1.7 | 1.7 |
| GCC (treated calcium | 46.1 | 46.1 |
| carbonates), d50: 2.8 μm | | |
| Printex G | 1.3 | 1.3 |
| Addworks 720 (HALS/AO/UVA) | 0.1 | 0.1 |
| Irganox 1135 (HALS) | 0.4 | 0.4 |
| Mesamoll | 16.3 | 16.3 |
| Oligomeric aminosilanes | 0.6 | 0.6 |
| Secondary aminosilanes | 1.3 | 1.3 |
| DBU | | 0.1 |
| K-KAT 670 (US 2022/0220245A1) | | |
| TIB-KAT 616 | | |
| TIB-KAT 716 | | |
| Total [g] | 100 | 100.1 |

| | Storage for 4 weeks under | | | | | |
|---|---|---|---|---|---|---|
| | the following conditions | | | | | |
| | initial | n.c. | 50° C. | initial | n.c. | 50° C. |
| Tensile strength | 45 | | | 35 | | |
| (1 week n.c.) | | | | | | |
| Elongation at | 2.44 | 2.37 | 2.29 | 2.20 | 1.96 | 1.43 |
| break (1 week n.c.) | | | | | | |
| Evolution of | — | 97% | 94% | — | 89% | 65% |
| tensile strength | | | | | | |
| after storage by | | | | | | |
| comparison with | | | | | | |
| original tensile | | | | | | |
| strength | | | | | | |
| Elongation at | 244% | 271% | 270% | 240% | 272% | 245% |
| break (1 week n.c.) | | | | | | |
| Adhesion to | yes*² | yes | yes | yes | no*³ | yes |
| teakwood | | | | | | |

| | Not according to | Not according to |
|---|---|---|
| | the invention | the invention |
| Polymer (MPeD/AA) from | 32.2 | 32.2 |
| example 1 | | |
| Polymer (7250) example 2 | | |
| Polymer (7230) example 3 | | |
| Polymer (7231) example 4 | | |
| Polymer (EPG/EPeD/SA) | | |
| example 5 | | |
| Polymer (MPeD/SA) example 6 | | |
| Water absorber (TMS-silane) | 1.7 | 1.7 |
| GCC (treated calcium | 46.1 | 46.1 |
| carbonates), d50: 2.8 μm | | |
| Printex G | 1.3 | 1.3 |
| Addworks 720 (HALS/AO/UVA) | 0.1 | 0.1 |
| Irganox 1135 (HALS) | 0.4 | 0.4 |
| Mesamoll | 16.3 | 16.3 |
| Oligomeric aminosilanes | 0.6 | 0.6 |
| Secondary aminosilanes | 1.3 | 1.3 |
| DBU | | |
| K-KAT 670 (US 2022/0220245A1) | 0.5 | |
| TIB-KAT 616 | | 0.5 |
| TIB-KAT 716 | | |
| Total [g] | 100.5 | 100.5 |

| | Storage for 4 weeks under | | | | | |
|---|---|---|---|---|---|---|
| | the following conditions | | | | | |
| | initial | n.c. | 50° C. | initial | n.c. | 50° C. |
| Tensile strength | 42 | | | | | |
| (1 week n.c.) | | | | | | |
| Elongation at | 2.30 | 1.86 | 1.29 | 2.17 | <0.1* | <0.1* |
| break (1 week n.c.) | | | | | | |
| Evolution of | — | 81% | 56% | — | 0% | 0% |
| tensile strength | | | | | | |
| after storage by | | | | | | |
| comparison with | | | | | | |
| original tensile | | | | | | |
| strength | | | | | | |
| Elongation at | 257% | 259% | 243% | 222% | n.a.* | n.a.* |
| break (1 week n.c.) | | | | | | |
| Adhesion to | yes | none | yes | yes | n.a.* | n.a.* |
| teakwood | | | | | | |

| | Not according to | Not according to |
|---|---|---|
| | the invention | the invention |
| Polymer (MPeD/AA) from | 32.2 | |
| example 1 | | |
| Polymer (7250) example 2 | | 32.2 |
| Polymer (7230) example 3 | | |
| Polymer (7231) example 4 | | |
| Polymer (EPG/EPeD/SA) | | |
| example 5 | | |
| Polymer (MPeD/SA) example 6 | | |
| Water absorber (TMS-silane) | 1.7 | |
| GCC (treated calcium | 46.1 | 46.1 |
| carbonates), d50: 2.8 μm | | |
| Printex G | 1.3 | 1.3 |
| Addworks 720 (HALS/AO/UVA) | 0.1 | 0.1 |
| Irganox 1135 (HALS) | 0.4 | 0.4 |
| Mesamoll | 16.3 | 16.3 |
| Oligomeric aminosilanes | 0.6 | 0.6 |
| Secondary aminosilanes | 1.3 | 1.3 |
| DBU | | |
| K-KAT 670 (US 2022/0220245A1) | | |
| TIB-KAT 616 | | |
| TIB-KAT 716 | 0.5 | |
| Total [g] | 100.5 | 100 |

| | Storage for 4 weeks under | | | | | |
|---|---|---|---|---|---|---|
| | the following conditions | | | | | |
| | initial | n.c. | 50° C. | initial | n.c. | 50° C. |
| Tensile strength | 46 | | | 36 | | |
| (1 week n.c.) | | | | | | |
| Elongation at | 2.22 | 1.92 | 1.22 | 2.48 | 2.02 | 1.58 |
| break (1 week n.c.) | | | | | | |
| Evolution of tensile | — | 86% | 55% | — | 81% | 64% |
| strength after | | | | | | |
| storage by comparison | | | | | | |
| with original | | | | | | |
| tensile strength | | | | | | |
| Elongation at | 234% | 233% | 237% | 190% | 166% | 169% |
| break (1 week n.c.) | | | | | | |
| Adhesion to | yes | no | yes | yes | mod- | no |
| teakwood | | | | | erate*⁴ | |

| | Not according to | Not according to |
|---|---|---|
| | the invention | the invention |
| Polymer (MPeD/AA) from | | |
| example 1 | | |
| Polymer (7250) example 2 | | |
| Polymer (7230) example 3 | 32.2 | |
| Polymer (7231) example 4 | | 32.2 |
| Polymer (EPG/EPeD/SA) | | |
| example 5 | | |
| Polymer (MPeD/SA) example 6 | | |
| Water absorber (TMS-silane) | 1.7 | 1.7 |
| GCC (treated calcium | 46.1 | 46.1 |
| carbonates), d50: 2.8 μm | | |
| Printex G | 1.3 | 1.3 |
| Addworks 720 (HALS/AO/UVA) | 0.1 | 0.1 |
| Irganox 1135 (HALS) | 0.4 | 0.4 |
| Mesamoll | 16.3 | 16.3 |
| Oligomeric aminosilanes | 0.6 | 0.6 |
| Secondary aminosilanes | 1.3 | 1.3 |
| DBU | | |
| K-KAT 670 (US 2022/0220245A1) | | |
| TIB-KAT 616 | | |
| TIB-KAT 716 | | |
| Total [g] | 100 | 100 |

| | Storage for 4 weeks under | | | | | |
|---|---|---|---|---|---|---|
| | the following conditions | | | | | |
| | initial | n.c. | 50° C. | initial | n.c. | 50° C. |
| Tensile strength | 47 | | | 41 | | |
| (1 week n.c.) | | | | | | |
| Elongation at | 2.23 | 1.65 | 1.09 | 2.27 | 1.83 | 1.21 |
| break (1 week n.c.) | | | | | | |
| Evolution of | — | 74% | 49% | — | 81% | 53% |
| tensile strength | | | | | | |
| after storage by | | | | | | |
| comparison with | | | | | | |
| original tensile | | | | | | |
| strength | | | | | | |
| Elongation at | 137% | 130% | 131% | 116% | 121% | 105% |
| break (1 week n.c.) | | | | | | |
| Adhesion to | yes | mod- | none | yes | mod- | no |
| teakwood | | erate | | | erate | |

| | According to | According to |
|---|---|---|
| | the invention | the invention |
| Polymer (MPeD/AA) from | | |
| example 1 | | |
| Polymer (7250) example 2 | | |
| Polymer (7230) example 3 | | |
| Polymer (7231) example 4 | | |
| Polymer (EPG/EPeD/SA) | 32.2 | |
| example 5 | | |
| Polymer (MPeD/SA) | | 32.2 |
| example 6 | | |
| Water absorber (TMS-silane) | 1.7 | 1.7 |
| GCC (treated calcium | 46.1 | 46.1 |
| carbonates), d50: 2.8 μm | | |
| Printex G | 1.3 | 1.3 |
| Addworks 720 (HALS/AO/UVA) | 0.1 | 0.1 |
| Irganox 1135 (HALS) | 0.4 | 0.4 |
| Mesamoll | 16.3 | 16.3 |
| Oligomeric aminosilanes | 0.6 | 0.6 |
| Secondary aminosilanes | 1.3 | 1.3 |
| DBU | | |
| K-KAT 670 (US 2022/0220245A1) | | |
| TIB-KAT 616 | | |
| TIB-KAT 716 | | |
| Total [g] | 100 | 100 |

| | Storage for 4 weeks under | | | | | |
|---|---|---|---|---|---|---|
| | the following conditions | | | | | |
| | initial | n.c. | 50° C. | initial | n.c. | 50° C. |
| Tensile strength | 53 | | | 50 | | |
| (1 week n.c.) | | | | | | |
| Elongation at | 2.74 | 3.10 | 2.47 | 2.42 | 2.54 | 2.43 |
| break (1 week n.c.) | | | | | | |
| Evolution of | — | 100% | 90% | — | 100% | 100% |
| tensile strength | | | | | | |
| after storage by | | | | | | |
| comparison with | | | | | | |
| original tensile | | | | | | |
| strength | | | | | | |
| Elongation at | 206% | 242% | 220% | 184% | 181% | 199% |
| break (1 week n.c.) | | | | | | |
| Adhesion to | yes | yes | yes | yes | yes | yes |
| teakwood | | | | | | |

n.c.=standard climatic conditions, 23° C./50% r.h.
(*) no curing
(*2) >90% cohesive failure
(*3)<40% cohesive failure
(*4) 40-90% cohesive failure
K-KAT 670 (sold by King Industry): zinc carboxylate/DBU mixture
TIB-KAT 616 (purchased by TIB Chemicals): zinc neodecanoate
TIB-KAT 716 (purchased by TIB Chemicals): bismuth carboxylate
DBU (n.a.): diazabicycloundecene

1. A method comprising joining together two wood materials using a composition containing at least 20% by weight of a silane-terminated polymer of the formula (I) or (II) 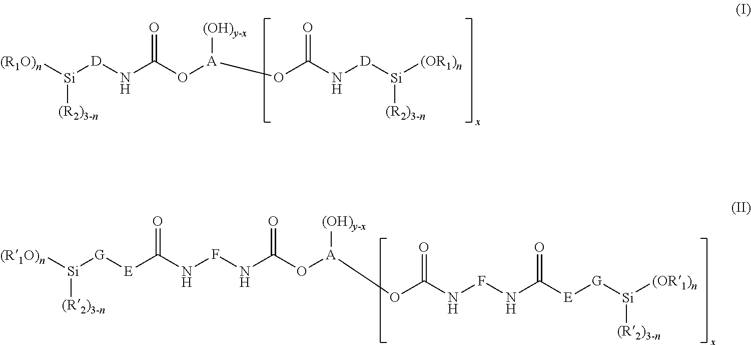
where
the percentages by weight are based on the total content of silane-terminated polymers,
D represents a linear or branched hydrocarbon group which has 1 to 20 hydrocarbon atoms and may optionally be interrupted by heteroatoms selected from the group consisting of oxygen, nitrogen and sulfur,
A is a polymer backbone selected from the group consisting of a polycarbonate, a polyester, a copolymer containing a polyester and/or a polycarbonate and a polymer containing at least one ester group and/or carbonate group, and where this polymer backbone contains multiple diol monomer units,
R₁, R₂, R₁′ and R₂′ are each independently a linear, branched or cyclic hydrocarbon radical which has 1 to 10 carbon atoms and may optionally comprise one or more heteroatoms selected from the group consisting of oxygen, sulfur and nitrogen,
n is 1, 2 or 3,
x and y are natural numbers from 1 to 10,
G is a linear or branched hydrocarbon group which has 1 to 20 hydrocarbon atoms and may optionally be interrupted by heteroatoms selected from the group consisting of oxygen, nitrogen and sulfur,
F is a linear, branched or cyclic organic radical which does not contain any isocyanate-reactive groups,
E is a functional group selected from the group consisting of NH, NR₄ and S, where
R₄ represents a linear, branched or cyclic hydrocarbon radical which has 1 to 10 carbon atoms and may optionally comprise one or more heteroatoms selected from the group consisting of oxygen, sulfur and nitrogen,
wherein
at least 60% of the diol monomer units present in the polymer backbone A are a diol of the general formula III 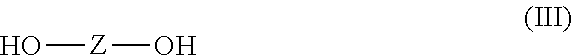
where
Z is a saturated or unsaturated hydrocarbon chain that may optionally contain one or more heteroatoms selected from the group consisting of oxygen, sulfur and a tertiary nitrogen, wherein Z has
(a) at least one side chain and/or
(b) at least one cyclic ring system and/or
(c) at least one double bond.
and the composition contains a curing catalyst and is free of
i. curing catalysts or residues thereof selected from the group of base catalysts having a pKa of greater than 15, and
ii. by-products that can form via elimination of a leaving group in the case of silane termination of the polymer.

2. The method as claimed in claim 1, wherein the composition is free of phthalate.

3. The method as claimed in claim 1, wherein the curing catalyst present in the composition contains an aminoalkoxysilane or consists of an aminoalkoxysilane or of a mixture of aminoalkoxysilanes.

4. The method as claimed in claim 1, wherein the composition contains a curing catalyst which is additionally free of a metal catalyst or residues thereof.

5. The method as claimed in claim 1, wherein Z has at least one side chain.

6. The method as claimed in claim 1, wherein Z is an alkylene group having at least one side chain.

7. The method as claimed in claim 1, wherein at least 75% of the diol monomer units present in the polymer backbone A contain a diol of the general formula III.

8. The method as claimed in claim 1, wherein the side chain is selected from the group consisting of methyl, ethyl, propyl, butyl, acrylate and methacrylate.

9. The method as claimed in claim 1, wherein the diol of the formula III is selected from the group consisting of neopentyl glycol, propane-1,2-diol, cyclohexane-1,4-dimethanol, 3-methylpentane-1,5-diol, 2-methylpentane-2,4-diol, hexane-2,5-diol, 2-butyl-2-ethylpropane-1,3-diol, 2-methylpropane-1,3-diol, 3-ethylpentane-1,5-diol, 2,4-diethylpentane-1,5-diol, 2,2,4-trimethylpentane-1,3-diol, butane-2,3-diol, 2-ethylpentane-1,5-diol, 2,2-dimethylpropane-1,3-diol, 1,5-hexadiene-3,4-diol, 7-octene-1,2-diol and (9Z,12Z)-18-[(6Z,9Z)-18-hydroxyoctadeca-6,9-dienoxy]octadeca-9,12-dien-1-ol or a mixture thereof.

10. The method as claimed in claim 1, wherein the silane-terminated polymers are selected from the group consisting of 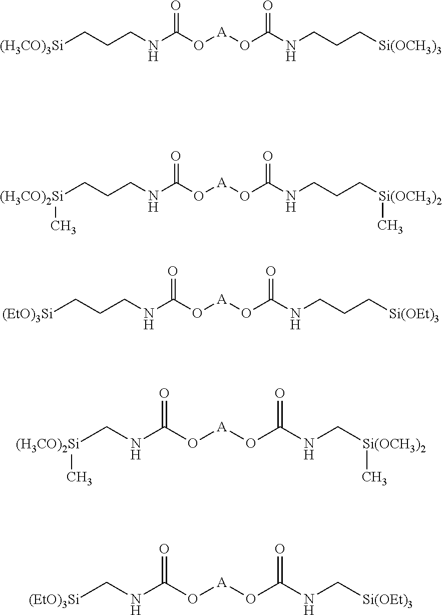
where the polymer backbone A contains polyester units formed from monomer units selected from the group consisting of:

| | | |
|---|---|---|
| A1 | neopentyl glycol | adipic acid |
| A2 | propane-1,2-diol | adipic acid |
| A3 | cyclohexane-1,4-dimethanol | adipic acid |
| A4 | 3-methylpentane-1,5-diol | adipic acid |
| A5 | 2-methylpentane-2,4-diol | adipic acid |
| A6 | hexane-2,5-diol | adipic acid |
| A7 | 2-butyl-2-ethylpropane-1,3-diol | adipic acid |
| A8 | 2-methylpropane-1,3-diol | adipic acid |
| A9 | 3-ethylpentane-1,5-diol | adipic acid |
| A10 | 2,4-diethylpentane-1,5-diol | adipic acid |
| A11 | 2,2,4-trimethylpentane- | adipic acid |
| | 1,3-diol | |
| A12 | butane-2,3-diol | adipic acid |
| A13 | 2-ethylpentane-1,5-diol | adipic acid |
| A14 | 2,2-dimethylpropane-1,3-diol | adipic acid |
| A15 | 1,5-hexadiene-3,4-diol | adipic acid |
| A16 | 7-octene-1,2-diol | adipic acid |
| A17 | (9Z,12Z)-18-[(6Z,9Z)-18- | adipic acid |
| | hydroxyoctadeca-6,9- | |
| | dienoxy]octadeca-9,12- | |
| | dien-1-ol | |
| A18 | neopentyl glycol | azelaic acid |
| A19 | propane-1,2-diol | azelaic acid |
| A20 | cyclohexane-1,4-dimethanol | azelaic acid |
| A21 | 3-methylpentane-1,5-diol | azelaic acid |
| A22 | 2-methylpentane-2,4-diol | azelaic acid |
| A23 | hexane-2,5-diol | azelaic acid |
| A24 | 2-butyl-2-ethylpropane- | azelaic acid |
| | 1,3-diol | |
| A25 | 2-methylpropane-1,3-diol | azelaic acid |
| A26 | 3-ethylpentane-1,5-diol | azelaic acid |
| A27 | 2,4-diethylpentane-1,5- | azelaic acid |
| | diol | |
| A28 | 2,2,4-trimethylpentane- | azelaic acid |
| | 1,3-diol | |
| A29 | butane-2,3-diol | azelaic acid |
| A30 | 2-ethylpentane-1,5-diol | azelaic acid |
| A31 | 2,2-dimethylpropane-1,3- | azelaic acid |
| | diol | |
| A32 | 1,5-hexadiene-3,4-diol | azelaic acid |
| A33 | 7-octene-1,2-diol | azelaic acid |
| A34 | (9Z,12Z)-18-[(6Z,9Z)-18- | azelaic acid |
| | hydroxyoctadeca-6,9- | |
| | dienoxy]octadeca-9,12- | |
| | dien-1-ol | |
| A35 | neopentyl glycol | sebacic acid |
| A36 | propane-1,2-diol | sebacic acid |
| A37 | cyclohexane-1,4- | sebacic acid |
| | dimethanol | |
| A38 | 3-methylpentane-1,5-diol | sebacic acid |
| A39 | 2-methylpentane-2,4-diol | sebacic acid |
| A40 | hexane-2,5-diol | sebacic acid |
| A41 | 2-butyl-2-ethylpropane- | sebacic acid |
| | 1,3-diol | |
| A42 | 2-methylpropane-1,3-diol | sebacic acid |
| A43 | 3-ethylpentane-1,5-diol | sebacic acid |
| A44 | 2,4-diethylpentane-1,5- | sebacic acid |
| | diol | |
| A45 | 2,2,4-trimethylpentane- | sebacic acid |
| | 1,3-diol | |
| A46 | butane-2,3-diol | sebacic acid |
| A47 | 2-ethylpentane-1,5-diol | sebacic acid |
| A48 | 2,2-dimethylpropane-1,3- | sebacic acid |
| | diol | |
| A49 | 1,5-hexadiene-3,4-diol | sebacic acid |
| A50 | 7-octene-1,2-diol | sebacic acid |
| A51 | (9Z,12Z)-18-[(6Z,9Z)-18- | sebacic acid |
| | hydroxyoctadeca-6,9- | |
| | dienoxy]octadeca-9,12- | |
| | dien-1-ol | |
| A52 | neopentyl glycol | terephthalic acid |
| A53 | propane-1,2-diol | terephthalic acid |
| A54 | cyclohexane-1,4-dimethanol | terephthalic acid |
| A55 | 3-methylpentane-1,5-diol | terephthalic acid |
| A56 | 2-methylpentane-2,4-diol | terephthalic acid |
| A57 | hexane-2,5-diol | terephthalic acid |
| A58 | 2-butyl-2-ethylpropane- | terephthalic acid |
| | 1,3-diol | |
| A59 | 2-methylpropane-1,3-diol | terephthalic acid |
| A60 | 3-ethylpentane-1,5-diol | terephthalic acid |
| A61 | 2,4-diethylpentane-1,5- | terephthalic acid |
| | diol | |
| A62 | 2,2,4-trimethylpentane- | terephthalic acid |
| | 1,3-diol | |
| A63 | butane-2,3-diol | terephthalic acid |
| A64 | 2-ethylpentane-1,5-diol | terephthalic acid |
| A65 | 2,2-dimethylpropane-1,3-diol | terephthalic acid |
| A66 | 1,5-hexadiene-3,4-diol | terephthalic acid |
| A67 | 7-octene-1,2-diol | terephthalic acid |
| A68 | (9Z,12Z)-18-[(6Z,9Z)-18- | terephthalic acid |
| | hydroxyoctadeca-6,9- | |
| | dienoxy]octadeca-9,12- | |
| | dien-1-ol | |
| A69 | neopentyl glycol | isophthalic acid |
| A70 | propane-1,2-diol | isophthalic acid |
| A71 | cyclohexane-1,4-dimethanol | isophthalic acid |
| A72 | 3-methylpentane-1,5-diol | isophthalic acid |
| A73 | 2-methylpentane-2,4-diol | isophthalic acid |
| A74 | hexane-2,5-diol | isophthalic acid |
| A75 | 2-butyl-2-ethylpropane- | isophthalic acid |
| | 1,3-diol | |
| A76 | 2-methylpropane-1,3-diol | isophthalic acid |
| A77 | 3-ethylpentane-1,5-diol | isophthalic acid |
| A78 | 2,4-diethylpentane-1,5-diol | isophthalic acid |
| A79 | 2,2,4-trimethylpentane- | isophthalic acid |
| | 1,3-diol | |
| A80 | butane-2,3-diol | isophthalic acid |
| A81 | 2-ethylpentane-1,5-diol | isophthalic acid |
| A82 | 2,2-dimethylpropane-1,3- | isophthalic acid |
| | diol | |
| A83 | 1,5-hexadiene-3,4-diol | isophthalic acid |
| A84 | 7-octene-1,2-diol | isophthalic acid |
| A85 | (9Z,12Z)-18-[(6Z,9Z)-18- | isophthalic acid |
| | hydroxyoctadeca-6,9- | |
| | dienoxy]octadeca-9,12- | |
| | dien-1-ol | |
| A86 | neopentyl glycol | naphthalenedicarboxylic |
| | | acid |
| A87 | propane-1,2-diol | naphthalenedicarboxylic |
| | | acid |
| A88 | cyclohexane-1,4-dimethanol | naphthalenedicarboxylic |
| | | acid |
| A89 | 3-methylpentane-1,5-diol | naphthalenedicarboxylic |
| | | acid |
| A90 | 2-methylpentane-2,4-diol | naphthalenedicarboxylic acid |
| A91 | hexane-2,5-diol | naphthalenedicarboxylic acid |
| A92 | 2-butyl-2-ethylpropane-1,3-diol | naphthalenedicarboxylic acid |
| A93 | 2-methylpropane-1,3-diol | naphthalenedicarboxylic acid |
| A94 | 3-ethylpentane-1,5-diol | naphthalenedicarboxylic acid |
| A95 | 2,4-diethylpentane-1,5-diol | naphthalenedicarboxylic |
| | | acid |
| A96 | 2,2,4-trimethylpentane-1,3-diol | naphthalenedicarboxylic |
| | | acid |
| A97 | butane-2,3-diol | naphthalenedicarboxylic |
| | | acid |
| A98 | 2-ethylpentane-1,5-diol | naphthalenedicarboxylic |
| | | acid |
| A99 | 2,2-dimethylpropane-1,3-diol | naphthalenedicarboxylic |
| | | acid |
| A100 | 1,5-hexadiene-3,4-diol | naphthalenedicarboxylic |
| | | acid |
| A101 | 7-octene-1,2-diol | naphthalenedicarboxylic |
| | | acid |
| A102 | (9Z,12Z)-18-[(6Z,9Z)-18- | naphthalenedicarboxylic |
| | hydroxyoctadeca-6,9- | acid |
| | dienoxy]octadeca-9,12-dien-1-ol | naphthalenedicarboxylic |

11. The method as claimed in claim 1, wherein A contains a polyester.

12. The method as claimed in claim 1, wherein A contains a polyester carbonate.

13. The method as claimed in claim 1, wherein the composition contains at least 25% by weight of a silane-terminated polymer of the formula (I) or (II), where the percentages by weight are based on the total content of silane-terminated polymers.

14. The method as claimed in claim 1, wherein the composition additionally contains one or more color pigments.

15. The method as claimed in claim 1, wherein the wood materials are hardwood.

16. The method as claimed in claim 1, wherein the wood materials are oily woods.

17. The method as claimed in claim 1, wherein the composition is applied as a join seal between the wood materials.
